(19) United States
(12) Patent Application Publication
(10) Pub. No.: US 2005/0285821 A1
(43) Pub. Date: Dec. 29, 2005

(54) Display device

(76) Inventors: Adrianus Sempel, Eindhoven (NL); Pieter Jacob Snijder, Eindhoven (NL); Remco Los, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/525,141

(22) PCT Filed: Jul. 18, 2003
(86) PCT No.: PCT/IB03/03277

§ 371 Date: Feb. 16, 2005

(30) Foreign Application Priority Data
Aug. 21, 2002 (EP) 02078455.9

(51) Int. Cl. G09G 3/30

(52) U.S. Cl. 345/76

(57) ABSTRACT

In a driver for a luminescent display feedback techniques, in particular techniques using a control amplifier (25), are used to reduce the power supply voltage.

The invention relates to a display device comprising at least one picture element and a display driver device comprising a driving transistor to be connected in series with the picture element.

Such display devices are increasingly based on electroluminescence-based semiconducting organic materials, also known as light emitting diodes (polyLEDs or OLEDs). The display devices may either luminesce via segmented pixels (or fixed patterns) but also display by means of a matrix pattern is possible. The adjustment of the diode current generally determines the intensity of the light to be emitted by the pixels.

Suitable fields of application of the display devices are, for example, mobile telephones, organizers, etc.

A display device of the type described in the opening paragraph is described in U.S. Pat. No. 6,014,119. In said document, the current through a LED is adjusted by means of current control. For each column of pixels in a matrix of luminescent pixels a current driver comprising a bipolar transistor and a resistor is provided as part of a driving circuit. In stead of the bipolar transistors MOS- or TFT-transistors may be used.

To obtain reproducible gray scales the current has to be substantially constant for a certain gray value. This is the reason why the transistors are used in the constant current region. In this case a high drain-source voltage (or emittor-collector voltage in the case of bipolar transistors) is used. This makes the bias of the transistor less sensitive to variations in the drain voltage due to variations in for instance the forward characteristics of the pixel diodes or the supply voltage of the driver. On the other hand the high drain-source voltage (or emittor-collector voltage in the case of bipolar transistors) increases power dissipation.

It is, inter alia, an object of the present invention to provide a display device of the type described in the opening paragraph in which the power dissipation due to the drain-source voltage (compliance voltage) adds to a lesser extent to the total power dissipation. To this end in a display device according to the invention the display driver comprises means for monitoring and controlling the current in said first current path.

In a preferred embodiment a controlling connection of the driving transistor is coupled to an output of a control amplifier each of the input connections of the control amplifier being coupled to the first and second current path respectively. By comparing the currents in the first and second current path the control amplifier now forces the current in the first current path to draw a certain current, while the drain-source voltage (compliance voltage) may be lower than necessary for use in the saturation region. This leads to lower power dissipation. The control amplifier can be realized in many different ways as known in the art (comparators, differential amplifiers, etc.).

In a further embodiment, suitable for active driving the current in the first current path is controlled by charge control e.g. by a charge stored by means of a current having passed in a second circuitry part.

These and other aspects of the invention are apparent from and will be elucidated with reference to the embodiments described hereinafter.

In the drawings:

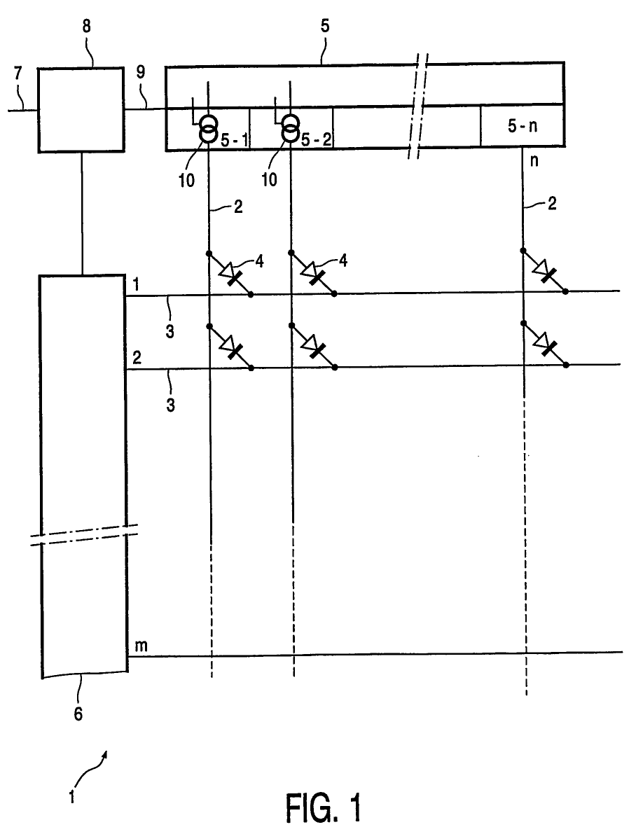

FIG. 1 shows diagrammatically a display device according to the invention,

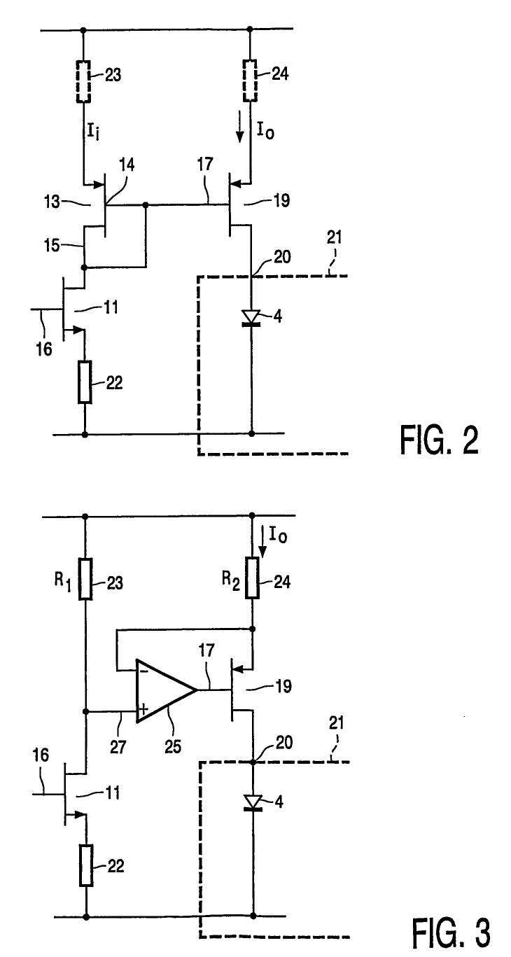

FIG. 2 shows a part of a display driver device,

FIG. 3 shows a first embodiment of a display driver device according to the invention,

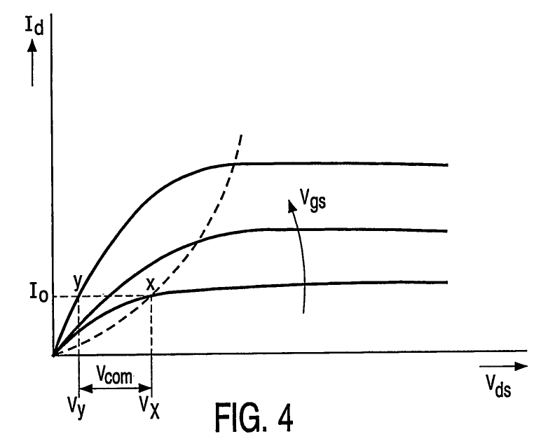

FIG. 4 shows transistor characteristics of the transistors used in the embodiments of FIGS. 2, 3 while

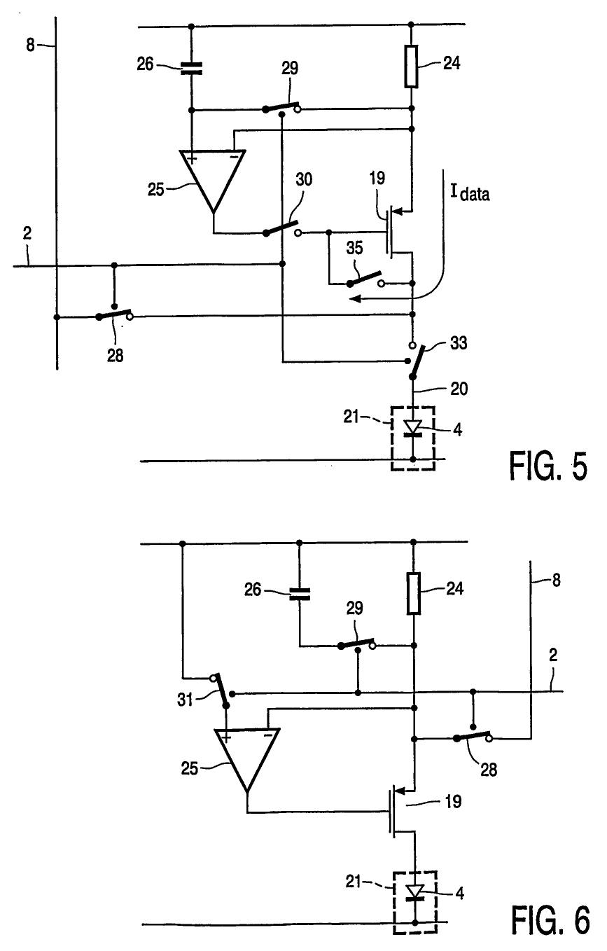

FIGS. 5 and 6 shows further embodiments of a display driver device according to the invention and

The Figures are diagrammatic; corresponding components are generally denoted by the same reference numerals.

FIG. 1 shows diagrammatically an equivalent circuit diagram of a part of a display device 1 according to the invention. This display device comprises a matrix of (P) LEDs or (O) LEDs 4 with n rows (1, 2, . . . , n) and m columns (1, 2, . . . , m). This device further comprises a row selection circuit 6 and a data register 5. Externally presented information 7, for example, a video signal, is processed in a processing unit 8 which, dependent on the information to be displayed, charges the separate parts 5-1, . . . , 5-n of the data register 5 via lines 9.

The selection of a row takes place by means of the row selection circuit 6 via the lines 3, in this example by providing them with the required selection voltage (passive addressing).

Writing data takes place in that, during selection, the current source 10, which may be considered to be an ideal current source, is switched on by means of the data register 5, for example via (not shown) switches. The value of the current is determined by the contents of the data register and is supplied to the LEDs 4 via data lines 2.

The current switch 10 may be of a simple type comprising just one transistor and one resistor. As explained in the introduction, to make the bias of the transistor less sensitive to variations in the drain voltage due to variations in for instance the forward characteristics of the pixel diodes or the supply voltage of the driver, the high drain-source, needed then, increases power dissipation.

FIG. 2 shows a known device comprising a first current path (transistor 19 and LED 4). The current I₀ flows in the LED 4 and determines the light intensity of the picture element. The dashed line 21 schematically depicts the display area in FIG. 2.

A second current path comprises a current source (a transistor 11 and a resistor 22) and a current mirror input stage, comprising a diode, realized by short-circuiting the gate terminal 14 and the drain terminal 15 of transistor 13 (and if necessary a further resistor 23). A voltage on gate terminal 16 determines the current Iᵢ in this second current path. Since the transistors 13, 19 (together with the resistor 23, and if necessary a further resistor 24) may be considered as a current mirror the current I₀ in the first current path is coupled to the current Iᵢ in a ratio, which ratio is determined by the k-factors of both transistors. In order to reduce the required drain-source voltage (compliance voltage) V_{ds}=V_{com} the drive voltage (V_{gs}−Vₜₕ, Vₜₕ: threshold voltage) of transistor 19 has to be small. In both current paths a resistor 23, 24 may be incorporated as is shown by dashed lines.

Using transistors, which have a large k-factor, increases the required area of the integrated driving circuit, since the required chip area is proportional with k˜W/1.

FIG. 3 shows a preferred embodiment of a device according to the invention comprising a first current path (transistor 19 and LED 4) again. The current I₀ flows in the LED 4 and determines the light intensity of the picture element. The dashed line 21 schematically depicts the display area in FIG. 2.

The first and second current paths are now coupled to each other via the control amplifier 25. The control amplifier 25 measures the output current I₀ via resistor 24(R₂), and compares it via the voltage over resistor 24 to the current Iᵢ as measured via resistor 23 (R₁). The control amplifier 25 then forces the output transistor 19 to draw I₀=Iᵢ·(R₁/R₂) by control of V_{gs}. So the current I₀ in the first current path is coupled to the current Iᵢ in a ratio(R₁/R₂).

This feedback allows a large V_{gs} value. This is shown in relation with FIG. 4. When used at the edge of saturation for I₀ the V_{ds} value is biased at point x. Due to the feedback mechanism at this (maximum) value for I₀ the V_{gs} value is biased, if necessary, at a I_{d}−V_{ds} curve related to a V_{ds} value for a much higher I₀ (e.g. at point y) without going into the saturation region, so the higher drain-source voltage (compliance voltage) for this higher I₀ has not to be taken into account when designing the driver.

So this feedback mechanism allows larger V_{gs} values. As a result lower k-values are possible and consequently a lower dissipation and smaller chip area are obtained.

The invention is applicable to both active and passive devices, matrix and segmented display devices. In one type of active matrices as shown in FIG. 5, which represents a single (sub)picture element, extra switches, such as (TFT) switches 28, 29, 30, 33 and 35 are used to select the picture element and charge an extra capacitor 26. During selection both transistor 19 and switches 28 and 29 are conducting as determined by selection line 2. The circuitry comprising resistor 24, capacitor 26, transistor 19 and switches 28 and 29 determines current path, which is controlled by data input 8 to define a current I_{data}. Capacitor 26 is charged to a voltage determined by the voltage across resistor 24. After selection (during a hold period), switches 28, 29, 35 are non-conducting, while the switches 30, 33 now are conducting. The charge remaining on capacitor 26 now controls the control amplifier 25 in such a way that the feedback mechanism maintains the current in current source 19,24 (and consequently in the LED 4 at I_{data}.

In the embodiment of FIG. 6, which represents a single (sub)picture element again, the extra (TFT) switches 28, 29, and 31 are used to select the picture element and charge the extra capacitor 26. During selection both transistor 19 and switches 28 and 29 are conducting again as determined by selection line 8. The circuitry comprising resistor 24, capacitor 26, transistor 19 and switches 28 and 29 again determines a current path, which is controlled by selection line 2 to define a current I_{data} again via data input 8 and charge capacitor 26. After selection (during a hold period), both switches 28, 29 are non-conducting, while the switch 31 now connects capacitor 26 to control amplifier 25 (positive input). The charge remaining on capacitor 26 controls the control amplifier 25 again in a similar way as in the previous example.

The protective scope of the invention is not limited to the embodiments described. Instead of measuring the currents I₀ and I_{I} in the first embodiment, fractions of these currents can be measured.

The invention is also applicable to field emission devices and other devices based on current driving.

The invention resides in each and every novel characteristic feature and each and every combination of features. Reference numerals in the claims do not limit the protective scope of these claims. The use of the verb “to comprise” and its conjugations does not exclude the presence of elements other than those stated in the claims. The use of the article “a” or “an” preceding an element does not exclude the presence of a plurality of such elements.

1. A display device comprising at least one picture element and a display driver device comprising a driving transistor to be connected in series with the picture element in a first current path, the display driver comprising means for monitoring and controlling the current in said first current path.

2. A display device as claimed in claim 1 in which in operation the current in the first current path is controlled by a current simultaneously passing in a second current path.

3. A display device as claimed in claim 2 a controlling connection of the driving transistor being coupled to an output of a control amplifier each of the input connections of the control amplifier being coupled to the first and second current path respectively.

4. A display device as claimed in claim 2 the driving transistor being a field effect transistor, the gate connection being the controlling connection.

5. A display device as claimed in claim 1 which in operation the current in the first current path is controlled by a charge stored by means of a current having passed in a second circuitry part.

6. A display device as claimed in claim 5 a controlling connection of the driving transistor being coupled to an output of a control amplifier one of the input connections of the control amplifier being coupled to a capacitor storing the control charge.

7. A display device as claimed in claim 5 a controlling connection of the driving transistor being coupled to an output of a control amplifier the input connections of the control amplifier being coupled to the capacitor storing the control charge and the first current path respectively.

8. A display device as claimed in claim 1 the picture element being a luminescent element and the first current determining the luminescence of the luminescent element.

9. A display driver device comprising a driving transistor for driving a picture element via first current path the first current path being controllable by the current in a second current path related to an input data value for the picture, a controlling connection of the driving transistor being coupled to an output of a control amplifier each of the input connections of the control amplifier being coupled to the first and second current path respectively.

10. A display driver device as claimed in claim 9 the driving transistor being a field effect transistor, the gate connection being the controlling connection.

11. A display driver device as claimed in claim 9 the second current path comprising a current source.

12. A display driver device comprising a driving transistor for driving a picture element via a first current path in which in operation the current in the first current path is controlled by a charge stored by means of a current having passed in a second circuitry part.

13. A display driver device as claimed in claim 12 a controlling connection of the driving transistor being coupled to an output of a control amplifier one of the input connections of the control amplifier being coupled to a capacitor storing the control charge.
